(19) United States
(12) Patent Application Publication
(10) Pub. No.: US 2026/0030965 A1
(43) Pub. Date: Jan. 29, 2026

(54) MULTI-SENSOR FOR INTRUSION DETECTION FENCE

(71) Applicant: SENSTAR CORPORATION, Carp (CA)

(72) Inventor: Jeremy Keith WEESE, Carp (CA)

(21) Appl. No.: 18/994,130

(22) PCT Filed: Jul. 20, 2023
(86) PCT No.: PCT/IB2023/057388

§ 371 Date: Jan. 14, 2025

(30) Foreign Application Priority Data
Jul. 21, 2022 (IL) 294948

(51) Int. Cl. G08B 13/196; G08B 13/16

(52) U.S. Cl. CPC G08B 13/19613; G08B 13/1672; G08B 13/19632

(57) ABSTRACT

A multi-sensor unit for mounting on a barrier and a method for detecting penetration of a barrier while utilizing this multi-sensor unit, wherein the multi-sensor unit comprises a case that is formed with anchoring means for mounting the unit on the barrier; and serves as a platform for plurality of sensors of different types, which are installed inside the case and were selected from a group of types of sensors that consist of sensors of the type that enable detection of volumetric movement near the unit, sensors of the type that enable detection of contact with the barrier near the unit; sensors of the type that enable picking up noises near the unit, and sensors that enable producing a visual image of what is happening in the vicinity of the unit.

### FIELD

The various embodiments described herein generally relate to security systems for compounds and border lines based on an intrusion detection fence, and particularly to sensors installed on the fence in such systems, to detect and warn of attempted intrusions through the fence.

### BACKGROUND OF THE INVENTION

Security systems for compounds and border lines based on an intrusion detection fence have been known in the art for a long time. In such systems, a fence (for example, a mesh fence or a taut wire fence) is deployed around the compound (for example, a compound housing a strategic facility) or along the line (for example, a border line), on posts, as a physical barrier designed to prevent penetration (of the compound) or crossing (of the border line).

In order to detect and warn of attempted intrusions through the fence of the type in question, sensors for detecting intrusions are installed the fence (on the surface of the fence, on the fence posts or on designated posts located near the fence).

The sensors may be of different types, for example, vibration sensors that sense the oscillations of the fence due to an attempt to penetrate the fence (for example, by cutting the fence wires or climbing over it), optical sensors (cameras) that allow for visually observing occurrences at the fence and in proximity to it, motion sensors that detect movements in the vicinity of the fence (for example, a person approaching the fence), and sound sensors that detect acoustic phenomena in the vicinity of the fence (for example, noises associated with cutting the fence or digging under it).

The sensors are connected to a control center (wired or wireless) that controls the area in which the fence is mounted. If necessary, the control center may launch into the area from which the sensor or sensor alerts were received, mobile security forces (manned or unmanned), additional sensors (for example, drones), and may also activate remote means (for example, lighting, public address, remotely controlled weapons).

The development of various sensor technologies, their availability at a relatively low cost, and the degree of reliability and certainty they provide for detecting intrusion attempts and providing appropriate alerts (for example, not only sensing shaking or rattling, but also and simultaneously, a visual display from the site of the fence from which vibration detection was received), led to the side-by-side installation of various types of sensors along intrusion detection fences. Multiple sensors of different types which naturally require different installations (depending on the type of sensors), wired or wireless communication to the control center from each type of sensor, supply of electrical power to each type of sensor, and extensive maintenance.

Attempts to integrate multiple different types of sensors are well known, for example, see publications U.S. Pat. Nos. 4,321,592; 5,517,429; 5,576,972; 8,120,524; 9,000,918.

However, prior to the invention that is the subject of this patent application, the need for unified sensor platforms remained unanswered, as discrete units each of which will provide reliable alert capabilities based on indications obtained from a number (plurality) of different sensing technologies that will be installed and integrated within it (in such a way that each unified, discrete platform will operate as a multi-sensor on its own), and in a way that will allow the installation of the unified platforms as discrete units on and along the fence in an easy and convenient manner for routine maintenance.

### SUMMARY OF THE INVENTION

Aspects and embodiments of the invention are directed to a multi-sensor platform that can be mounted on a barrier, such as a fence or a wall, as a discrete unit, and allows for the sensing and transmission of appropriate indications to a remote control center, when there is movement nearby, shaking of the barrier on which it is mounted, acoustic noises, and also provides the ability to send a visual image of what is happening in close proximity.

According to one embodiment, a multi-sensor unit according to the invention comprises a case, which is designed with anchoring means that enable the installation of the unit on the barrier and serves as a platform for several different types of sensors, which are installed inside the case and selected from a group of sensors that consist sensors of the type that allows sensing the occurrence of volumetric movements near the unit, sensors of the type that allows sensing contact with the barrier in close proximity to the unit, sensors of the type that provide for hearing noises (sound) near the unit, and sensors of the type that allows for producing a visual image of what is happening in close proximity to the unit.

Another embodiment of the invention is a barrier system along which multi-sensor units according to the invention are mounted in a spaced apart formation.

In another and additional embodiment, the invention embodies a method for detecting intrusion of a barrier and comprises the steps of: providing multiple multi-sensor units according to the invention, mounting the units on the barrier, along the barrier and spaced apart, connecting the units to a control center, and activating at least some of the sensors installed in each of the units, in order to receive indications at the control center of attempts to intrude and penetrate the barrier.

Still other aspects, embodiments, and advantages of these exemplary aspects and embodiment are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE FIGURES

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 depicts an illustration in perspective view of a section of an intrusion detection fence on which is mounted an example of a multi-sensor platform according to the invention and the sensing challenges to which it responds.

FIGS. 2a-2c depict perspective views (2a, 2b) from different angles of an example of a multi-sensor platform according to the invention, and its side view (2c) in open state.

FIG. 3 depicts a perspective view of a sample of an electronic circuit mounted in an example of a multi-sensor platform according to the invention.

### DETAILED DESCRIPTION

Aspects and embodiments of the invention are directed to a multi-sensor platform that can be mounted as a unit on a barrier, such as a fence or wall, and allows sensing and sending appropriate indications to a remote control center, when there is nearby movement, shaking of the barrier on which it is mounted, acoustic noise, and also provides the ability to transmit a visual image of what is happening near the fence. As well as a security system for compounds and border lines, which is based on a barrier, such as an intrusion detection fence, and on which and along which is mounted, as discrete units and spaced apart, a multi-sensor platforms according to the invention, and in addition to the method embodied in the operation of multi-sensor platforms according to the invention.

It is to be appreciated that embodiments of the methods and apparatuses discussed herein are not limited in application to the details of construction and the arrangement of components set forth in the following description or illustrated in the accompanying figures. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising.” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

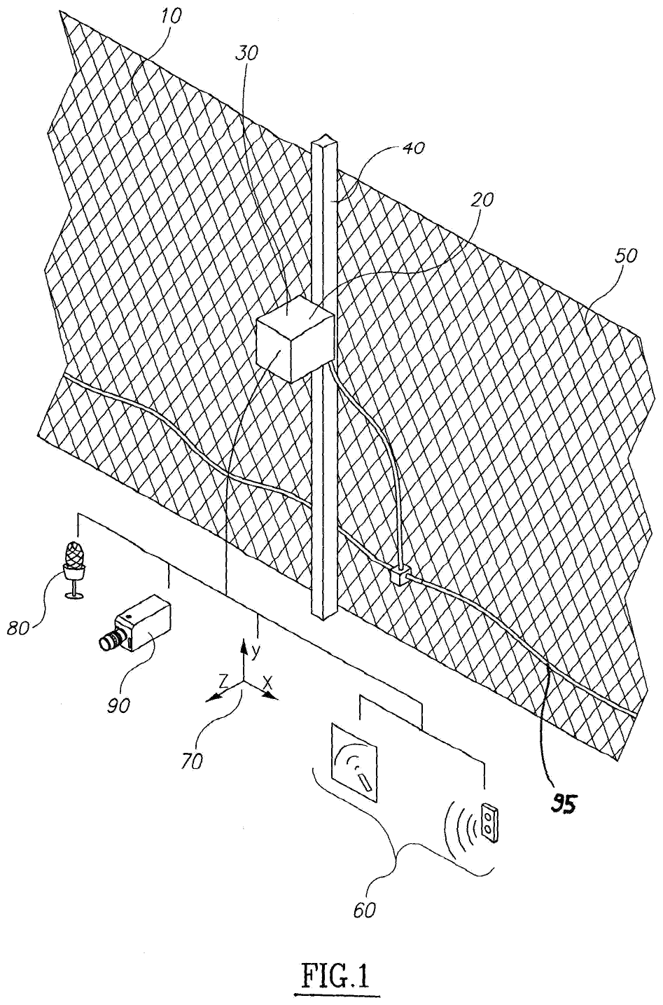

Referring to FIG. 1, there is Illustrated in perspective view of a section of intrusion detection fence 10 on which is mounted an example of multi-sensor platform 20 according to the invention, and the sensing challenges to which it responds.

Multi-sensor unit 20 comprises case 30, which is designed with an anchoring means (not illustrated) that allows for mounting the unit on the barrier. According to the illustrated example, multi-sensor unit 20 is mounted on post 40 which supports wire mesh type barrier 50.

A person skilled in the art will understand that a multi-sensor unit according to the invention may be mounted in differently (for example, directly on the surface of a fence that is stretched between posts or on a barrier in a wall configuration), and on various types of barriers (for example, a taut wire fence that is not in a mesh configuration, or a wall, etc.).

According to the invention, each multi-sensor unit 20 serves as a platform for several (plurality of) different types of sensors, which are mounted inside case 30 and were selected from a group of sensor types, consisting of sensors of the type that allow for sensing volume movements near unit 60, sensors of the type that allow for sensing contact with the barrier near unit 70, sensors of the type that allow for picking up noises near unit 80, and sensors of the type that enable producing a visual image of what is happening in proximity to 90.

A person skilled in the art will understand that multi-sensor unit 20 is connected to a remote control center (not illustrated), via wired communication (as shown in the illustrated example, cable 95) or wireless communication, for transmitting indications from the sensors and to the control center and receiving commands from it. A person skilled in the art will also understand that the electrical power needed to operate the sensors and the communication from them may be supplied by wired communication (as shown in the illustrated example, using the same cable 95), or by means of an internal battery which may be rechargeable or replaceable from time to time.

Sensing capability 60 of the presence of volume movements in the vicinity of a multi-sensor platform according to the invention (such as the movements of an intruder before touching or coming into contact with the fence) may be implemented by mounting a Lidar radar on the platform.

Lidar (also LIDAR, or LiDAR; sometimes LADAR) is a method for determining ranges (variable distance) by targeting an object or a surface with a laser and measuring the time for the reflected light to return to the receiver. It can also be used to make digital 3-D representations of areas by varying the wavelength of light. It has terrestrial, airborne, and mobile applications. Lidar is an acronym of “light detection and ranging” or “laser imaging, detection, and ranging” It is sometimes called 3-D laser scanning, a special combination of 3-D scanning and laser scanning.

Another possible component for such an embodiment is the Infineon BGT24LTR11 N 16 24 GHz Radar MMIC.

Such radar components may be integrated on a standard FR4 PCB, and the fitting of a multi-sensor platform according to the invention inside a case made of a polymeric material does not impair their operation in any weather condition. The mounting of such radar components on the platform may enable sensing volumetric motion at a range of up to 5-10 meters.

A passive IR sensor is another possible component that may be incorporated to enable the detection of the presence of volumetric movement near a multi-sensor platform according to the invention (next to or instead of a radar component).

Sensor capability 70 of a vibratory occurrence in or on a barrier on which a multi-sensor platform according to the invention is mounted may be implemented by installing an accelerometer on the platform. A 3-axis accelerometer allows vibrations to be sensed in all types of fences and in a wall-type barrier (at least, as long as it is not made of heavy concrete of considerable thickness). A person skilled in the art knows that this is a proven touch sensor technology that does not pose particular challenges in terms of the electrical power it required for operation, the ability to pack it into a compact case, and low cost.

Possible components for such an application are the Adafruit MMA8451 Triple-Axis Accelerometer w/14-bit ADC; ST LIS3DHH 3-axis accelerometer, ultra-high resolution, low-noise, SPI 4-wire digital output, ±2.5 g full-scale; analog devices ADXL313 3-Axis, ±0.5 g/±1 g/±2 g/±4 g digital accelerometer.

Audible capability 80 of noises near the barrier on which a multi-sensor platform according to the invention is mounted may be implemented by installing microphones on the platform. Thus, for example, an ultrasonic MEMS microphone may be installed on the platform without using significant electrical power and will allow the transmission of a sound indication of, for example, human footsteps, sounds of talking, and digging noises near the platform.

A person skilled in the art will also understand that integrating sound sensors on a platform according to the invention may also provide the system with additional capabilities, such as detecting the passage of a noisy aircraft over the barrier and the location of the airborne object (e.g. a drone); and due to the deployment of platforms according to the invention at measured intervals along the barrier, then, in combination with synchronization of nodes with reference clock (IEEE 1588/Time Sensitive Networking (TSN)), and known algorithms, it can also detect the location of hostile weapons whose muzzle blasts and the noise of the passage of the bullet over the barrier were picked up by microphones.

A possible microphone for this embodiment is TDK InvenSense EV INMP621-FX EVAL BOARD MEMS MIC INMP621.

The ability to produce visual image 90 of what is happening in the vicinity of the barrier on which a multi-sensor platform according to the invention is mounted may be implemented by installing a camera on the platform. A person skilled in the art is aware of the countless supply of camera modules that can be installed and operated even in low-light/NIR conditions without the need for optical accessories, other than a small window in the platform case.

Possible camera modules for this application are OMNIVISION RGB-Ir CMOS (1920×1280) High Dynamic Range (HDR) High Definition Image Sensor with Nyxel® Technology (also known as OX03A2S 2.5MP); OMNIVISION OVM9724-RADA Image Sensor Color 1280×720Pixels/IC image sensor 720P 28-CSP3.

A person skilled in the art will understand that a multi-sensor platforms according to the invention may be operated in a way that not all of its sensing capabilities are activated simultaneously, but in a gradual and controlled operation of the sensing capabilities, subject to receiving an indication from one active sensor (e.g. an indication of the occurrence of volumetric movement near the barrier may lead to a decision in the remote control center to activate (“revive”) the additional sensing capabilities, in whole or in part), which naturally means a significant savings in the power supply needed prior to receiving the indication, redirects bandwidth required for communication transmission, and reduces wear and tear on the various sensors and the risk of malfunctions.

A person skilled in the art will also understand that indications received from the various sensors in the multi-sensor platform according to the invention may be combined for the sake of verification (for example, an indication from a vibration sensor combined with an indication from a sound sensor).

A person skilled in the art will also understand that at the remote control to which multi-sensor platforms according to the invention are connected (by wired or wireless communication), or in addition or alternatively, in the multi-sensor platform according to the invention themselves, machine learning/artificial intelligence computer technologies may be implemented to be based on the indications received from the sensors in order to draw a conclusion about a definite intrusion attempt and present it as such to the team manning the control center.

A person skilled in the art will understand that communication via a system comprising multiple multi-sensor platforms according to the invention, which are connected to a control center, may be conducted by node networking, i.e., redistribution points or communication endpoints where each multi-sensor is an electronic device that is attached to a network and is capable of creating, receiving, or transmitting information over a communication channel.

A possible communication protocol for the application is EtherCAT (Ethernet for Control Automation Technology) which is an Ethernet-based fieldbus system. The protocol is standardized in IEC 61158 and is suitable for hard and soft real-time computing requirements in automation technology. Other option (instead of industrial Ethernet) is RS-422.

Synchronization of the nodes with reference clock is also applicable either by EtherCAT node that measures time difference between leaving and returning frame or by switch port with integrated IEEE 1588 boundary clock.

In terms of system topology, it could be a flexible tree structures—arbitrarily extendable. Topology variants like line, star, tree daisy chain plus drop lines are possible and can be used in any combination. Up to 65,535 nodes are available for each EtherCAT segment (if implemented) with standard Ethernet cabling. Methods of master-to-slave, slave-to-slave and master-to-master are applicable for redundancy.

The processor requirements are EtherCAT Support (if chosen), camera interface which aligns with image sensor, and possible candidates is Infineon XMC4300 (Arm Cortex M4/256 kB Flash/128 kB RAM) and TI Sitara AM3357 (ARM Cortex A8/Ext Mem).

The electrical power can be distributed 48VDC provided by separate higher gauge power pair or on communication bus.

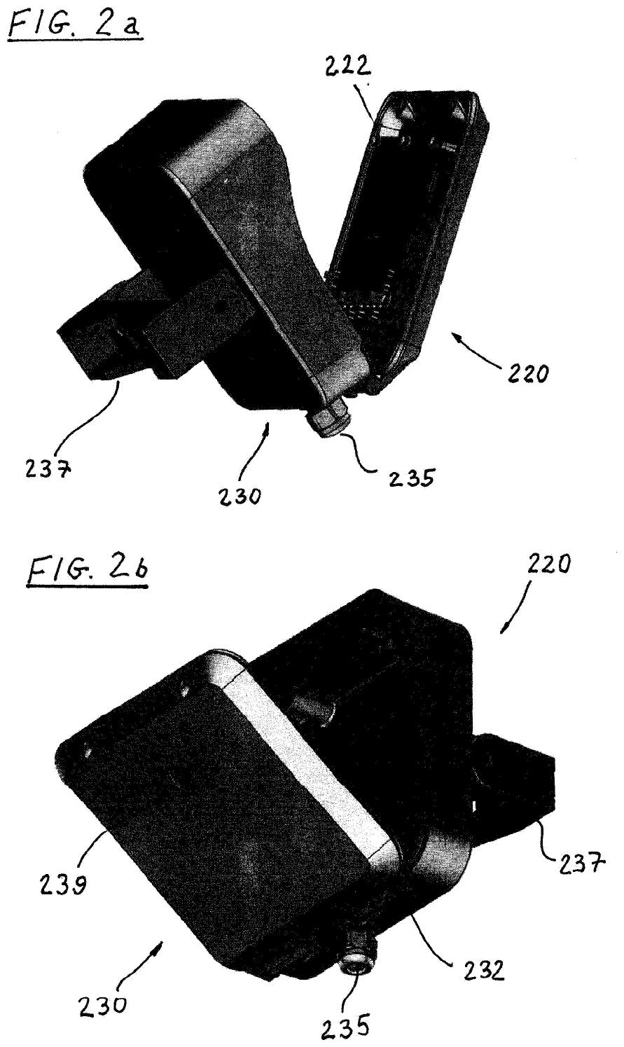

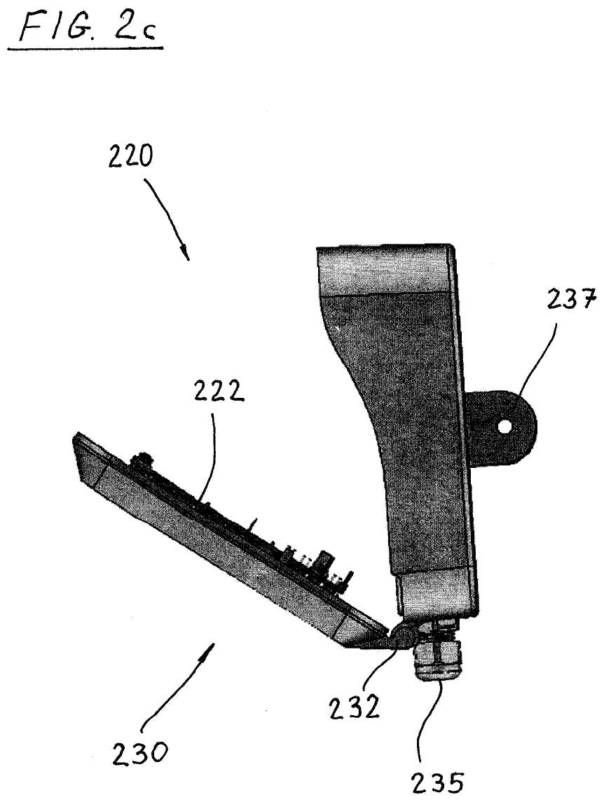

Referring to FIGS. 2a-2c. FIGS. 2a-2c are perspective views (2a, 2b) from different angles of an example of a multi-sensor platform 220 according to the invention, and its side view (2c) in open mode.

According to the illustrated example, in multi-sensor unit 220 according to the invention, the sensors are mounted on a PCB electronic circuit 222 which is fitted inside case 230. Case 230 is formed as a sort of closed box that protects the contents of the unit from ravages of the weather and vandalism. Case 230 may be made of a polymeric material and comprises hinge means 232, which allows the case to be opened in a manner that provides access to the sensors (as required for maintenance purposes). Case 230 is additionally formed at its bottom with connector 235 for anchoring the communication wiring to multi-sensor unit 220 from it and for supplying the electrical power to it. In addition, the rear of case 230 is formed with anchoring means 237 for mounting the unit on the barrier (according to the illustrated example, when installed on a fence post). Case 230 is also formed with window 239, as required for the operation of a sensor of a type that allows for producing a visual image of what is happening in the vicinity of the unit (e.g. a CMOS image sensor).

A skilled person will understand that this is only an example, and a case of multi-sensor unit according to the invention may be formed in other different configurations (in a routine mechanical design), so that these other and different configurations will allow the incorporation of sensors in them to protect them from weather damage and vandalism, enable to provide access from time to time the sensors, the wiring of the communication and power supply, to mount the unit on the barrier, and to activate the optical sensor from inside it.

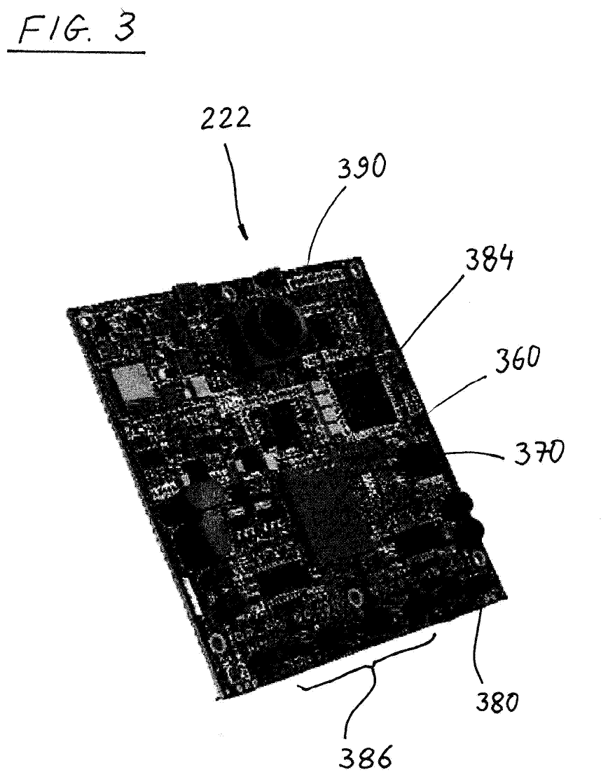

Referring to FIG. 3. FIG. 3 is a is a perspective view of an example of PCB electronic circuit 222, which is mounted in example 220 of a multi-sensor platform according to the invention (see above with reference to FIGS. 2a-2c).

According to the illustrated example, mounted on the PCB surface are: a sensor of the type that enables the detection of the occurrence of volumetric movements near unit 360 (in the illustrated example, a radar component), a sensor of the type enabling detection of contact with barrier unit 370 (in the illustrated example, a 3-axis accelerometer), a sensor of the type enabling hearing of noise near unit 380 (in the illustrated example, a MEMS microphone), and a sensor of the type that allows for producing a visual image of occurrences in proximity to unit 390 (in the illustrated example, a CMOS image sensor).

AI processor 384, and IR Leds 386 components can also be seen on the PCB surface.

Therefore, in light of the description given above and in referring to the accompanying figures, a person skilled in the art will appreciate that a multi-sensor unit according to the invention (20, 220) can be a unified sensor platform, a discrete unit which in itself provides reliable alert capabilities based on indications obtained from a number (plurality) of different sensing technologies that are all installed and integrated inside it, thereby allowing the unit to be mounted as a discrete unit on the barrier and along it by installing several units at intervals, in a way that is conducive for easy and convenient routine maintenance.

Moreover, in light of the above description and in referring to the accompanying figures, a person skilled in the art will appreciate the invention is also embodied in a comprehensive barrier system (such as a fence or a wall), on which, along which and at intervals, multi-sensor units (20, 220) according to the invention are mounted.

Finally, in light of the above description and in referring to the accompanying figures, a person skilled in the art will appreciate that the invention embodies a general method of detecting intrusions through a barrier. A method that comprises the steps of providing plurality of multi-sensor units according to the invention (20, 220), mounting the units on barrier (10), along it and at intervals, connecting the units to a control center, and operating at least some of the sensors (60, 70, 80, 90, 360, 370, 380, 390) mounted in each unit, for the reception of indications at the control center about attempts to penetrate the barrier.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

1. A multi-sensor unit for mounting on a barrier, which comprises
a case that is formed with anchoring means for mounting the unit on the barrier; and
serves as a platform for plurality of sensors of different types, which are installed inside the case and were selected from a group of types of sensors that consist of:
sensors of the type that enable detection of volumetric movement near the unit, sensors of the type that enable detection of contact with the barrier near the unit; sensors of the type that enable picking up noises near the unit, and sensors that enable producing a visual image of what is happening in the vicinity of the unit.

2. A multi-sensor unit according to claim 1, wherein said sensors of the type that enable detection of volumetric movement near the unit, comprising a radar or IR passive component.

3. A multi-sensor unit according to claim 1, wherein said sensors of the type that enable detection of contact with the barrier near the unit, comprising a 3-axis accelerometer.

4. A multi-sensor unit according to claim 1, wherein said sensors of the type that enable detection of noises near the unit, comprising a MEMS microphone.

5. A multi-sensor unit according to claim 1, wherein said sensors of the type that enable producing a visual image of what is happening in the vicinity of the unit, comprising a CMOS image sensor.

6. A multi-sensor unit according to claim 1, wherein said sensors are mounted on a PCB which is packed inside said case.

7. A multi-sensor unit according to claim 1, wherein said case is made of a polymeric material and comprises a hinge means that enables opening the case to provide access to said sensors.

8. A multi-sensor unit according to claim 1, wherein said barrier is a mesh or wire fence that extends between posts; and wherein said anchoring means is adapted for connection to a fence post.

9. A barrier system on which are mounted, along it and at intervals, multi-sensor units according to claim 1.

10. A method for detecting penetration of a barrier, which comprises the following steps:
providing multi-sensor units according to claim 1; and
mounting said units on the barrier, along it and at intervals;
connection of said units to a control center; and
activation of at least some of said sensors mounted in each of said multi-sensor units for receipt of indications by said control center of an attempted intrusion of the barrier.

11. A barrier system on which are mounted, along it and at intervals, multi-sensor units according to claim 2.

12. A barrier system on which are mounted, along it and at intervals, multi-sensor units according to claim 3.

13. A barrier system on which are mounted, along it and at intervals, multi-sensor units according to claim 4.

14. A barrier system on which are mounted, along it and at intervals, multi-sensor units according to claim 5.

15. A barrier system on which are mounted, along it and at intervals, multi-sensor units according to claim 6.

16. A barrier system on which are mounted, along it and at intervals, multi-sensor units according to claim 7.

17. A barrier system on which are mounted, along it and at intervals, multi-sensor units according to claim 8.

18. A method for detecting penetration of a barrier, which comprises the following steps:
providing multi-sensor units according to claim 2; and
mounting said units on the barrier, along it and at intervals;
connection of said units to a control center; and
activation of at least some of said sensors mounted in each of said multi-sensor units for receipt of indications by said control center of an attempted intrusion of the barrier.

19. A method for detecting penetration of a barrier, which comprises the following steps:
providing multi-sensor units according to claim 3; and
mounting said units on the barrier, along it and at intervals;
connection of said units to a control center; and
activation of at least some of said sensors mounted in each of said multi-sensor units for receipt of indications by said control center of an attempted intrusion of the barrier.

20. A method for detecting penetration of a barrier, which comprises the following steps:
providing multi-sensor units according to claim 4; and
mounting said units on the barrier, along it and at intervals;
connection of said units to a control center; and
activation of at least some of said sensors mounted in each of said multi-sensor units for receipt of indications by said control center of an attempted intrusion of the barrier.
